(19) United States
(12) Patent Application Publication
(10) Pub. No.: US 2025/0059327 A1
(43) Pub. Date: Feb. 20, 2025

(54) POLYIMIDE, PRODUCING METHOD OF IMIDE COMPOUND, AND PRODUCING METHOD OF RECYCLED POLYIMIDE

(71) Applicant: Panasonic Intellectual Property Management Co., Ltd., Osaka (JP)

(72) Inventors: KOTA ANDO, Osaka (JP); TERUHIKO SAITO, Osaka (JP); HONAMI INOBE, Osaka (JP)

(21) Appl. No.: 18/935,673

(22) Filed: Nov. 4, 2024

Related U.S. Application Data
(63) Continuation of application No. PCT/JP2023/014789, filed on Apr. 12, 2023.

(30) Foreign Application Priority Data
May 24, 2022 (JP) 2022-084848

(51) Int. Cl. C08G 73/10; C08J 11/28

(52) U.S. Cl. CPC C08G 73/106; C08J 11/28; C08J 2379/08

(57) ABSTRACT

A polyimide includes a non-crosslinked structure including a main chain. The main chain includes a Si—O—C bond. The main chain may include a C—O—Si—O—C bond. The main chain includes, for example, a group denoted by —OSi(R₁)(R₂)O—. At least one oxygen atom included in the group bonds to, for example, a carbon atom adjacent to the group to form the Si—O—C bond.

### BACKGROUND

### 1. Technical Field

The present disclosure relates to a polyimide, a producing method of an imide compound, and a producing method of a recycled polyimide.

### 2. Description of the Related Art

Molded articles of thermosetting resins such as polyimides have excellent chemical resistance and, therefore, tend not to readily dissolve in any solvent. The molded articles have excellent heat resistance and, therefore, tend not to be readily melted and reused in contrast to thermoplastic resins such as polystyrenes. Consequently, the molded articles are not readily subjected to and are unsuitable for regeneration treatment or recycling treatment, and the molded articles are disposed of by landfill or disposed of by incineration. In the present specification, molded articles include films.

### SUMMARY

In one general aspect, the techniques disclosed here feature a polyimide comprising a non-crosslinked structure including a main chain. The main chain includes a Si—O—C bond.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a flow chart illustrating an imide compound producing method according to an embodiment of the present disclosure;

FIG. 2 is a flow chart illustrating a recycled polyimide producing method according to an embodiment of the present disclosure;

FIG. 3 is a graph illustrating a ¹H-NMR spectrum of a polyamic acid in Measurement example 1;

FIG. 4 is a graph illustrating an infrared absorption spectrum of a polyimide in Measurement example 1; and

FIG. 5 is a graph illustrating a ¹H-NMR spectrum of a decomposition product of a polyimide in Measurement example 1.

### DETAILED DESCRIPTIONS

From the viewpoint of a global environmental pollution problem, resource depletion, and the like, technologies to effectively reuse thermosetting resins, in particular, polyimides, have been desired.

It is an object of the present disclosure to provide a new polyimide suitable for reuse.

### Underlying Knowledge Forming Basis of the Present Disclosure

Polyimides serving as engineering plastics have excellent heat resistance, mechanical characteristics, sliding characteristics, and the like. Therefore, in recent years, demands for polyimides have rapidly intensified in electric and electronic equipment applications, automobile component applications, aerospace industrial applications, office appliance applications, and the like.

For example, a polyimide film can be produced by applying a coating liquid containing a polyamic acid serving as a precursor of a polyimide, drying the resulting coating film, and imidizing the polyamic acid through a cyclodehydration reaction by heating or the like. A resin molded article such as a polyimide film is very rigid, has favorable electric characteristics, abrasion resistance, and the like, and has excellent chemical resistance and heat resistance. As an example, the polyimide is insoluble in chemicals such as organic solvents and does not melt even at high temperature. However, in contrast to many resins including common engineering plastics, resin molded articles such as polyimide films do not have satisfiable characteristics since bonding at resin interface is insufficient in the molded articles even when the molded articles are reproduced after pulverization.

From the viewpoint of improving the mechanical characteristics, insulation performance, and the like, composite materials of the polyimide and fiber materials such as glass fibers, carbon fibers, and the like are known. However, since the polyimide has high heat resistance and solvent resistance, the fiber material is also disposed of by pulverization and landfill. Consequently, a technology to separate and recover the polyimide and the fiber material from the composite material is also desired.

To date, chemical recycle in which the polyimide is converted to another compound, and the converted compound is reused as a raw material has also been investigated. For example, hydrolysis of the polyimide by an acid or alkali aqueous solution has been attempted. However, according to this method, since the components of the resulting decomposition product are not uniform, the characteristics of the product produced by recycling the decomposition product tend to become low. Consequently, there is room for improvement in the material recycle process of the polyimide.

When chemical recycle is considered, a silicon-oxygen bond may be used as a bond that can be formed and cut. For example, regarding a silyl protective group known as a protective group of an alcohol, a silicon-oxygen bond is cut by a reaction with a fluorine anion, and deprotection can be thereby performed.

Japanese Unexamined Patent Application Publication No. 2013-87148 discloses alkaline hydrolysis of a polyimide by using a basic aqueous solution. According to this method, the polyimide can be decomposed into a low-molecular-weight product. A polyimide film can be homogenously dissolved in a solvent due to decomposition.

However, according to this method, since the decomposition product has a complex composition, it is difficult to reuse the decomposition product.

Each of Japanese Unexamined Patent Application Publication No. 2022-12362, Japanese Unexamined Patent Application Publication No. 2021-195319, and Lin Fan et al., “High Thermally Stable and Melt Processable Polyimide Resins Based on Phenylethynyl-Terminated Oligoimides Containing Siloxane Structure” Materials, 2020, vol. 13, p. 3742 (Non Patent Literature 1) discloses a polyimide containing a silicon atom. However, the polyimides disclosed in these literatures are not produced in consideration of being decomposed and reused. In particular, the polyimide in Non Patent Literature 1 has a complex crosslinked structure. For example, a polyimide in Non Patent Literature 1 has a crosslinked structure derived from a carbon-carbon triple bond and a crosslinked structure containing a silicon atom. Consequently, the decomposability is low. In this regard, even when the polyimide in Non Patent Literature 1 is decomposed, since the resulting decomposition product has a complex crosslinked structure, reuse is difficult. The polyimides in Japanese Unexamined Patent Application Publication No. 2022-12362 and Japanese Unexamined Patent Application Publication No. 2021-195319 have low solvent resistivity and tend to have a high thermal expansion coefficient.

### Characteristics of Polyimide

The polyimide tends to have high heat resistance, flame retardancy, and mechanical characteristics. Further, the polyimide has high electric insulation performance and, therefore, may be used as an insulating material or a substrate material of an electronic circuit. Despite the organic material, the linear thermal expansion coefficient of the polyimide is very low and is a value close to metal. Consequently, when the polyimide is used as an insulating material of an electronic circuit, due to a difference in the thermal expansion between the polyimide and a metal wiring line, distortion does not readily occur, and the wiring line can be processed with high precision.

### Polyimide Synthesis Method

In general, the polyimide can be synthesized by condensing equimolar amounts of diamine and acid anhydride. As an example, the polyimide can be synthesized by reacting a diamine with an acid anhydride in a highly polar organic solvent and heating the resulting polyamic acid at high temperature. In the present specification, a step of synthesizing a polyimide by subjecting a polyamic acid to heating treatment or the like is also referred to as imidization.

### Polyimide Molding Method

In general, the polyimide does not have thermoplasticity and is insoluble in various organic solvents. Therefore, molding is performed by a method in which a solution containing a high concentration of polyamic acid serving as a precursor is applied and imidized.

### Polyimide Decomposition Method

In general, a molded article of the polyimide does not have thermoplasticity and is frequently insoluble in various solvents. Therefore, the molded article is not readily melted and reused, in contrast to thermoplastic resins. Regarding the molded article, a hydrolysis reaction under a high-temperature, high-pressure condition, a decomposition and recovery method by using an alkali aqueous solution or the like, and other methods have been proposed. However, regarding decomposition under a high-temperature, high-pressure condition, a large amount of energy is input. When a strong acid is used for decomposition, a neutralization step or the like is necessary after the treatment.

### Sophistication of Polyimide

The characteristics, such as thermophysical properties, the mechanical characteristics, the electric insulation performance, and the optical characteristics, of the polyimide can be appropriately designed in accordance with an intended application by adjusting the types of a diamine and an acid anhydride used as raw materials, as the situation demands. Therefore, two or more types of diamines may be used in combination. For example, to realize low thermal expansibility, a diamine and an acid anhydride having rigidity and high linearity may be selected. However, regarding a polyimide formed from only a rigid monomer, entanglement between main chains tends to be poor. Consequently, as the situation demands, a method in which a polyimide is synthesized by partly mixing a diamine capable of imparting bendability may be used. To decrease the permittivity and the water absorption of the polyimide, a diamine or an acid anhydride having a fluorine-containing group such as a trifluoromethyl group may be selected. In this regard, a polyimide having low permittivity and high transparency may be obtained by selecting an alicyclic acid anhydride. To impart adhesiveness and flexibility to the polyimide, a diamine having a polysiloxane structure may be selected. In such an instance, the polyimide has a clearer phase-separated structure with increasing length of a polysiloxane structure in the diamine. It is known that, in such an instance, the characteristics, such as a surface state, of the polyimide change to a great extent. A polyimide soluble in an organic solvent may be obtained due to the characteristics changing to a great extent. The resulting polyimide may be used for applications such as adhesives.

As described above, in the technical field of the polyimide, many molecular structures contributing to physical properties are designed. On the other hand, as far as the present inventors know, regarding the polyimide, the design of the molecular structure for the purpose of reuse, such as impartation of decomposability, has not been realized until now. As a result of intensive investigation by the present inventors, a new polyimide capable of being readily decomposed when unneeded or the like was realized.

### Outline of Aspect According to the Present Disclosure

A polyimide according to a first aspect of the disclosure includes a non-crosslinked structure including a main chain. The main chain includes a Si—O—C bond.

The polyimide according to the first aspect can be readily decomposed by, for example, a reaction with a fluorine-containing compound. The polyimide is suitable for reuse.

In a second aspect of the present disclosure, for example, regarding the polyimide according to the first aspect, the main chain may include a C—O—Si—O—C bond.

When the polyimide according to the second aspect is decomposed by the fluorine-containing compound, an imide compound that is a decomposition product has, for example, two hydroxy groups. The imide compound can be readily reused.

In a third aspect of the present disclosure, for example, regarding the polyimide according to the first aspect or the second aspect, the main chain may include a group denoted by —OSi(R₁)(R₂)O—, and at least one oxygen atom included in the group may bond to a carbon atom adjacent to the group to form the Si—O—C bond. In the group, R₁ and R₂ may each independently include at least one atom selected from the group consisting of H, C, N, O, S, F, Cl, Br, and I.

In a fourth aspect of the present disclosure, for example, regarding the polyimide according to any one of the first aspect to the third aspect, the non-crosslinked structure may include a first constitutional unit denoted by Formula (A1),

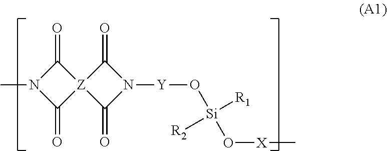

in Formula (A1),
   R₁ and R₂ may each independently include at least one atom selected from the group consisting of H, C, N, O, S, F, Cl, Br, and I,
   X and Y may each independently represent a divalent group including at least one atom selected from the group consisting of H, C, N, O, S, F, Cl, Br, and I,
   Z may represent a tetravalent group including at least one atom selected from the group consisting of H, C, N, O, S, F, Cl, Br, and I, and
at least one selected from the group consisting of X and Y may include a carbon atom that bonds to an adjacent oxygen atom to form the Si—O—C bond.

In a fifth aspect of the present disclosure, for example, regarding the polyimide according to any one of the first aspect to the fourth aspect, the non-crosslinked structure may include a second constitutional unit denoted by Formula (A2),

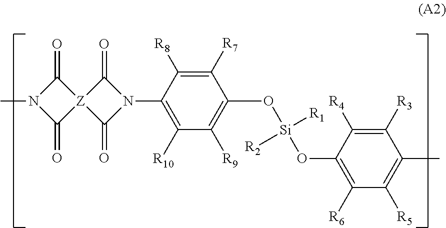

in Formula (A2),
   R₁ to R₁₀ may each independently include at least one atom selected from the group consisting of H, C, N, O, S, F, Cl, Br, and I, and
   Z may represent a tetravalent group including at least one atom selected from the group consisting of H, C, N, O, S, F, Cl, Br, and I.

When the polyimide according to the third aspect to the fifth aspect is decomposed by the fluorine-containing compound, an imide compound that is a decomposition product has an alcohol structure such as a phenol structure at a terminal thereof. The imide compound can be more simply reused.

In a sixth aspect of the present disclosure, for example, regarding the polyimide according to any one of the first aspect to the fifth aspect, the non-crosslinked structure may include a third constitutional unit denoted by Formula (A3),

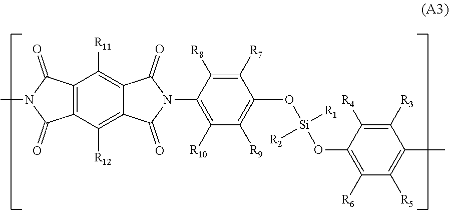

in Formula (A3), R₁ to R₁₂ may each independently include at least one atom selected from the group consisting of H, C, N, O, S, F, Cl, Br, and I.

In a seventh aspect of the present disclosure, for example, regarding the polyimide according to any one of the first aspect to the sixth aspect, the non-crosslinked structure may include a fourth constitutional unit denoted by Formula (A4),

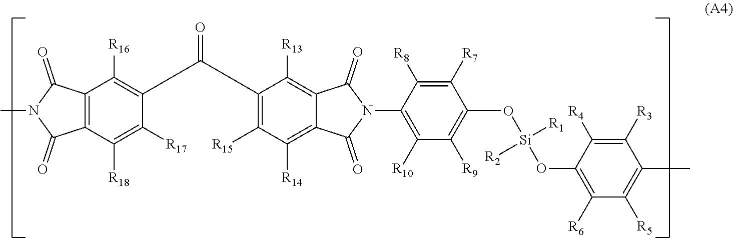

in Formula (A4), R₁ to R₁₀ and R₁₃ to R₁₈ may each independently include at least one atom selected from the group consisting of H, C, N, O, S, F, Cl, Br, and I.

The polyimides according to the sixth aspect and the seventh aspect tend to have excellent solvent resistance and thermophysical properties. A coating liquid including a polyamic acid serving as a precursor of the polyimide tends to have excellent applicability and film-formability. The polyimides according to the sixth aspect and the seventh aspect can be readily decomposed when unneeded by, for example, a reaction with a fluorine-containing compound. When the polyimide is decomposed, an imide compound having a phenol structure at a terminal and being suitable for reuse can be obtained.

In an eighth aspect of the present disclosure, for example, regarding the polyimide according to any one of the third aspect to the seventh aspect, R₁ and R₂ may each independently represent a hydrogen atom or a hydrocarbon group having a carbon number of greater than or equal to 1 and less than or equal to 6.

The polyimide according to the eighth aspect can be readily synthesized. Further, the polyimide can be readily decomposed by, for example, a reaction with a fluorine-containing compound.

A polyimide according to a ninth aspect of the present disclosure may include a main chain including a Si—O—C bond. A ratio of the number of silicon atoms included in the main chain to the number of imide groups included in the main chain may be greater than or equal to 2% and less than or equal to 50%.

In a tenth aspect of the present disclosure, for example, regarding the polyimide according to the first aspect or the ninth aspect, a weight average molecular weight may be greater than or equal to 1,000.

The polyimides according to the ninth aspect and the tenth aspect tend to have favorable solvent resistance and thermophysical properties.

In the polyimide according to an aspect of the present disclosure, the non-crosslinked structure may include a plurality of constitutional units. For example, the non-crosslinked structure may include the third constitutional unit denoted by Formula (A3) and the fourth constitutional unit denoted by Formula (A4).

A producing method of an imide compound according to an eleventh aspect of the present disclosure includes
bringing the polyimide according to any one of the first aspect to the tenth aspect into contact with a fluorine-containing compound, and
obtaining an imide compound that is a decomposition product of the polyimide by reacting the polyimide with the fluorine-containing compound.

According to the eleventh aspect, an imide compound can be readily produced by decomposing the polyimide.

In a twelfth aspect of the present disclosure, for example, regarding the producing method according to the eleventh aspect, the fluorine-containing compound may include a fluoride salt.

According to the twelfth aspect, an imide compound can be produced by using a relatively readily available, inexpensive fluoride salt.

In a thirteenth aspect of the present disclosure, for example, regarding the producing method according to the twelfth aspect, the fluoride salt may include tetrabutylammonium fluoride.

According to the thirteenth aspect, for example, an imide compound can be produced by decomposing the polyimide at room temperature.

A producing method of a recycled polyimide according to a fourteenth aspect of the present disclosure includes
obtaining a decomposition product of the polyimide according to any one of the first aspect to the tenth aspect by decomposing the polyimide, and
synthesizing a recycled polyimide by using the decomposition product.

According to the fourteenth aspect, the polyimide can be reused.

The embodiment according to the present disclosure will be described below with reference to the drawings. The present disclosure is not limited to the embodiment below.

### Embodiment

A polyimide P according to the present embodiment has a Si—O—C bond in a main chain. In other words, the polyimide P includes a constitutional unit A having a Si—O—C bond in a main chain. From the viewpoint of ease of recycle, the polyimide P may have a C—O—Si—O—C bond in a main chain. For example, when the polyimide P having a C—O—Si—O—C bond in a main chain is decomposed, an imide compound having two hydroxy groups is obtained. The resulting imide compound can be readily reused.

The polyimide P is composed of a non-crosslinked structure. That is, the polyimide P does not has a crosslinked structure, and polyimides having a crosslinked structure are excluded. In particular, the polyimide P excludes polyimides including a plurality of main chains where the plurality of main chains are cross-linked to each other. In other words, in the polyimide P according to the present embodiment, the number of main chain is 1. In the polyimide P, for example, the main chain linearly extends. In this regard, the polyimide P according to the present embodiment is a main chain having a Si—O—C bond and does not have a plurality of main chains. Such a polyimide P may include a constitutional unit having a crosslinkable structure.

The polyimide P may has a group g denoted by —OSi(R₁)(R₂)O—. In other words, in the polyimide P, the above-described constitutional unit A may have a group g. At least one oxygen atom contained in the group g forms a Si—O—C bond by bonding to, for example, a carbon atom adjacent to the group g.

In the group g, R₁ and R₂ may be the same or differ from each other. R₁ and R₂ may each independently contain at least one atom selected from the group consisting of H, C, N, O, S, F, Cl, Br, and I. R₁ and R₂ may each independently contain at least one atom selected from the group consisting of H, C, O, F, Cl, Br, and I. R₁ and R₂ may each independently represent a hydrogen atom, a halogen atom, or a hydrocarbon group.

Examples of the halogen atom include F, Cl, Br, and I. In the present specification, a halogen atom is also referred to as a halogen group.

There is no particular limitation regarding the carbon number of the hydrocarbon group. For example, the carbon number may be greater than or equal to 1 and less than or equal to 20, may be greater than or equal to 1 and less than or equal to 10, or may be greater than or equal to 1 and less than or equal to 6. The hydrocarbon group may be linear, may be branched-chain-shaped, or may be circular.

Examples of the hydrocarbon group include aliphatic saturated hydrocarbon groups, alicyclic hydrocarbon groups, aliphatic unsaturated hydrocarbon groups, and aromatic hydrocarbon groups. The aliphatic saturated hydrocarbon groups may be alkyl groups. Examples of the aliphatic saturated hydrocarbon group include —CH₃, —CH₂CH₃, —CH₂CH₂CH₃, —CH(CH₃)₂, —CH(CH₃)CH₂CH₃, —C(CH₃)₃, —CH₂CH(CH₃)₂, —(CH₂)₃CH₃, —(CH₂)₄CH₃, —C(CH₂CH₃)(CH₃)₂, —CH₂C(CH₃)₃, —(CH₂)₅CH₃, —(CH₂)₆CH₃, —(CH₂)₇CH₃, —(CH₂)₈CH₃, —(CH₂)₉CH₃, —(CH₂)₁₀CH₃, —(CH₂)₁₁CH₃, —(CH₂)₁₂CH₃, —(CH₂)₁₃CH₃, —(CH₂)₁₄CH₃, —(CH₂)₁₅CH₃, —(CH₂)₁₆CH₃, —(CH₂)₁₇CH₃, —(CH₂)₁₈CH₃, and —(CH₂)₁₉CH₃. Examples of the alicyclic hydrocarbon group include a cyclopropyl group, a cyclobutyl group, a cyclopentyl group, a cyclohexyl group, and an adamanthyl group. Examples of the aliphatic unsaturated hydrocarbon group include —CH═CH₂, —C≡CH, —C≡CCH₃, —C(CH₃)═CH₂, —CH═CHCH₃, and —CH₂CH═CH₂. Examples of the aromatic hydrocarbon group include a phenyl group.

R₁ and R₂ may each independently represent a hydrogen atom or a hydrocarbon group having a carbon number of greater than or equal to 1 and less than or equal to 6, may represent a methyl group or a phenyl group, or may represent a methyl group. When, each of R₁ and R₂ represents a hydrogen atom or a hydrocarbon group having a carbon number of greater than or equal to 1 and less than or equal to 6, since R₁ and R₂ have small steric hindrance, for example, a reaction between the polyimide P and the fluorine-containing compound is not readily hindered. In other words, since the Si—O bond in the polyimide P can be readily cut by the reaction with the fluorine-containing compound, the polyimide P can be readily decomposed. When each of R₁ and R₂ represent a hydrogen atom or a hydrocarbon group having a carbon number of greater than or equal to 1 and less than or equal to 6, the polyimide P tends to be simply synthesized since a raw material is relatively readily available.

In the polyimide P, the above-described constitutional unit A may be denoted by Formula (A1). In other words, the polyimide P may include the constitutional unit A1 denoted by Formula (A1).

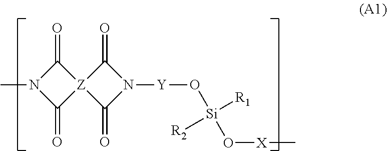

In Formula (A1), R₁ and R₂ each independently contain at least one atom selected from the group consisting of H, C, N, O, S, F, Cl, Br, and I. Examples of R₁ and R₂ include the above described with respect to the group g.

X and Y each independently represent a divalent group containing at least one atom selected from the group consisting of H, C, N, O, S, F, Cl, Br, and I. At least one selected from the group consisting of X and Y contains, for example, a carbon atom that bonds to an adjacent oxygen atom to form the Si—O—C bond.

X and Y may each independently represent a divalent hydrocarbon group that may have a substituent. Examples of the divalent hydrocarbon group include an arylene group and an alkylene group. Each of X and Y may represent a phenylene group that may have a substituent. In such an instance, the polyimide P being decomposed enables an imide compound having a phenol structure at a terminal and being suitable for reuse to be obtained. Examples of the substituent of the divalent hydrocarbon group include the above described with respect to R₁ and R₂ of the group g.

Z represents a tetravalent group containing at least one atom selected from the group consisting of H, C, N, O, S, F, Cl, Br, and I. Examples of Z include groups denoted by Formula (i) and groups denoted by Formula (ii).

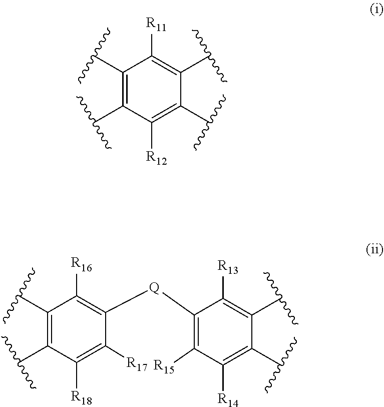

In Formula (i), R₁₁ and R₁₂ each independently contain at least one atom selected from the group consisting of H, C, N, O, S, F, Cl, Br, and I. Examples of R₁₁ and R₁₂ include the above described with respect to R₁ and R₂ of the group g. R₁₁ and R₁₂ may each represent a hydrogen atom.

In Formula (ii), R₁₃ to R₁₈ each independently contain at least one atom selected from the group consisting of H, C, N, O, S, F, Cl, Br, and I. Examples of R₁₃ to R₁₈ include the above described with respect to R₁ and R₂ of the group g. R₁₃ to R₁₈ may each represent a hydrogen atom.

In Formula (ii), Q represents a single bond or a divalent group containing at least one atom selected from the group consisting of H, C, N, O, S, F, Cl, Br, and I. Regarding Q, examples of the divalent group include at least one functional group selected from the group consisting of an ether group, an acyl group, an ester group, and a sulfonyl group. The divalent group may include an acyl group. The divalent group may include a divalent hydrocarbon group in place of the above-described functional group or in addition to the above-described functional group. The divalent hydrocarbon group may further have a substituent other than the above-described functional group. Examples of the divalent hydrocarbon group include the above described with respect to X and Y.

When Z represents the group denoted by Formula (ii), the polyimide P tends to have flexibility.

Z may represent a group other than the groups denoted by Formula (i) and Formula (ii). As an example, Z may represent a group including an alicyclic hydrocarbon group. In such an instance, the polyimide P tends to have high transparency.

The constitutional unit A may be denoted by Formula (A2). In other words, the polyimide P may include a constitutional unit A2 denoted by Formula (A2).

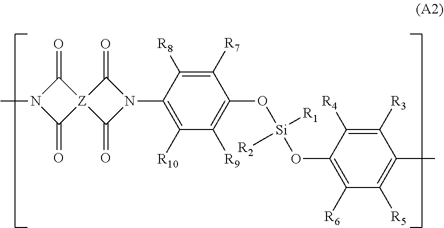

In Formula (A2), R₁ to R₁₀ each independently contain at least one atom selected from the group consisting of H, C, N, O, S, F, Cl, Br, and I. Examples of R₁ to R₁₀ include the above described with respect to R₁ and R₂ of the group g. R₃ to R₁₀ may each represent a hydrogen atom.

In Formula (A2), Z represents a tetravalent group containing at least one atom selected from the group consisting of H, C, N, O, S, F, Cl, Br, and I. Examples of Z include the above described with respect to Formula (A1).

The constitutional unit A may be denoted by Formula (A3) or Formula (A4). In other words, the polyimide P may include at least one selected from the group consisting of a constitutional unit A3 denoted by Formula (A3) and a constitutional unit A4 denoted by Formula (A4).

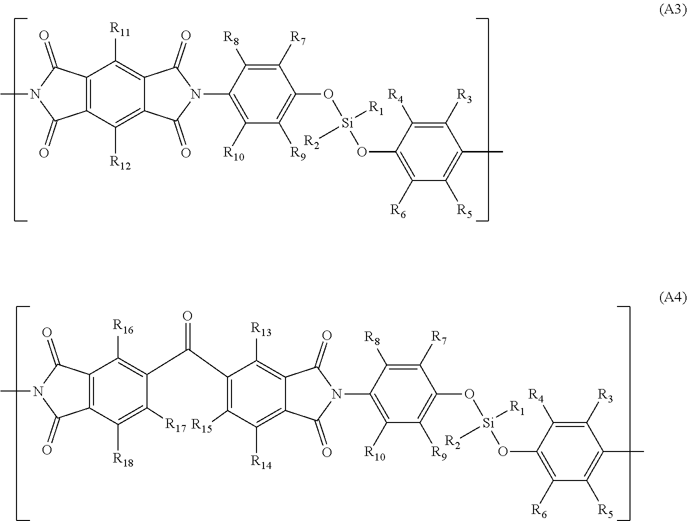

In Formula (A3), R₁ to R₁₂ each independently contain at least one atom selected from the group consisting of H, C, N, O, S, F, Cl, Br, and I. Examples of R₁ to R₁₂ include the above described with respect to R₁ and R₂ of the group g.

In Formula (A4), R₁ to R₁₀ and R₁₃ to R₁₈ each independently contain at least one atom selected from the group consisting of H, C, N, O, S, F, Cl, Br, and I. Examples of R₁ to R₁₀ and R₁₃ to R₁₈ include the above described with respect to R₁ and R₂ of the group g.

The content of the constitutional unit A in the polyimide P is, for example, greater than or equal to 2% by mole, may be greater than or equal to 5% by mole, may be greater than or equal to 10% by mole, may be greater than or equal to 30% by mole, may be greater than or equal to 50% by mole, may be greater than or equal to 80% by mole, and may be greater than or equal to 90% by mole. The polyimide P may be composed of substantially only the constitutional unit A. However, as the situation demands, the content of the constitutional unit A in the polyimide P may be less than or equal to 80% by mole.

The polyimide P may further include a constitutional unit B other than the constitutional unit A. Typically, the constitutional unit B does not have a Si—O—C bond. The constitutional unit B is denoted by, for example, Formula (B1).

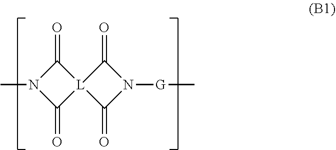

In Formula (B1), G represents a divalent group containing at least one atom selected from the group consisting of H, C, N, O, S, F, Cl, Br, and I. Regarding G, the divalent group includes at least one functional group selected from the group consisting of, for example, an ether group, an acyl group, an ester group, an amide group, a sulfide group, a disulfide group, and a sulfonyl group. The divalent group may include an ether group. For example, the divalent group includes a divalent hydrocarbon group in addition to the above-described functional group. The divalent hydrocarbon group may further have a substituent other than the above-described functional group. Examples of the divalent hydrocarbon group include the above described with respect to X and Y. The divalent group may include a phenylene group in addition to an ether group.

L represents a tetravalent group containing at least one atom selected from the group consisting of H, C, N, O, S, F, Cl, Br, and I. Examples of L include the above described with respect to Z.

The constitutional unit B may be denoted by Formula (B2) or Formula (B3). In other words, the polyimide P may include at least one selected from the group consisting of a constitutional unit B2 denoted by Formula (B2) and a constitutional unit B3 denoted by Formula (B3).

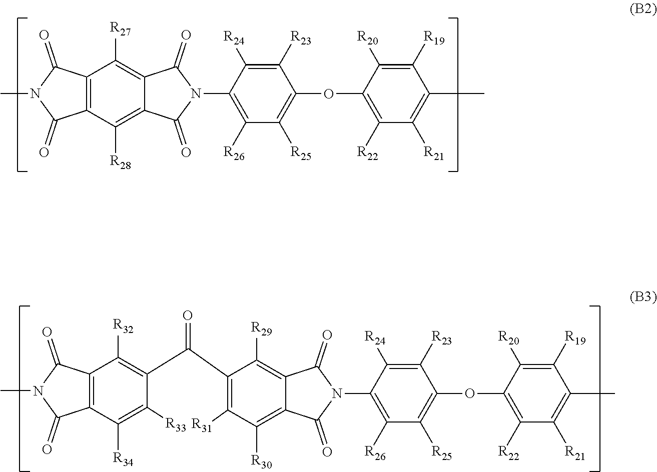

In Formula (B2), R₁₉ to R₂₈ each independently contain at least one atom selected from the group consisting of H, C, N, O, S, F, Cl, Br, and I. Examples of R₁₉ to R₂₈ include the above described with respect to R₁ and R₂ of the group g. R₁₉ to R₂₈ may each represent a hydrogen atom.

In Formula (B3), R₁₉ to R₂₆ and R₂₉ to R₃₄ each independently contain at least one atom selected from the group consisting of H, C, N, O, S, F, Cl, Br, and I. Examples of R₁₉ to R₂₆ and R₂₉ to R₃₄ include the above described with respect to R₁ and R₂ of the group g. R₁₉ to R₂₆ and R₂₉ to R₃₄ may each represent a hydrogen atom.

There is no particular limitation regarding the content of the constitutional unit B in the polyimide P. The content is, for example, less than or equal to 98% by mole, may be less than or equal to 95% by mole, may be less than or equal to 90% by mole, may be less than or equal to 70% by mole, may be less than or equal to 50% by mole, may be less than or equal to 20% by mole, and may be less than or equal to 10% by mole. The polyimide P is not limited to including the constitutional unit B. However, as the situation demands, the content of the constitutional unit B in the polyimide P may be greater than or equal to 20% by mole.

The polyimide P may be denoted by Formula (1).

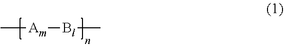

In Formula (1), A represents the constitutional unit A, and B represents the constitutional unit B. Each of n, m, and 1 independently represents an optional integer. The physical properties of the polyimide P denoted by Formula (1) are readily adjusted in accordance with the molecular design akin to that of the polyimide in the related art.

In the polyimide P, a ratio p of the number of silicon atoms to the number of imide groups is, for example, greater than or equal to 2%. More specifically, in the polyimide P including a main chain having a Si—O—C bond, a ratio p of the number of silicon atoms contained in the main chain to the number of imide groups contained in the main chain is greater than or equal to 2% and less than or equal to 50%. The ratio p may be greater than or equal to 2% and less than or equal to 40%, may be greater than or equal to 2% and less than or equal to 30%, or may be greater than or equal to 2% and less than or equal to 10%. In other words, the ratio p may satisfy 2%≤p≤50%, 2%≤p≤40%, 2%≤p≤30%, or 2%≤p≤10%. The ratio p being adjusted to within the above-described range enables the solvent resistance and the thermophysical properties of the polyimide P to be suppressed from deteriorating. Further, a coating liquid containing a polyamic acid serving as a precursor of the polyimide P tends to have favorable viscosity and have excellent applicability and film-formability.

In addition, regarding the polyimide P, the main chain having a Si—O—C bond is readily decomposed. Consequently, an imide compound that is a decomposition product of the polyimide P can be readily obtained. In this regard, the resulting imide compound has favorable solubility in an organic solvent and can be used for producing a recycled polyimide.

The weight average molecular weight of the polyimide P is, for example, greater than or equal to 1,000, may be greater than or equal to 2,500, may be greater than or equal to 5,000, or may be greater than or equal to 10,000. There is no particular limitation regarding the upper limit of the weight average molecular weight of the polyimide P, and the upper limit is, for example, 1,000,000.

The polyimide P can be synthesized by a reaction between a diamine and tetracarboxylic dianhydride. In the present specification, tetracarboxylic dianhydride is also referred to simply as an acid anhydride. Examples of the diamine for forming the constitutional unit A include the following.

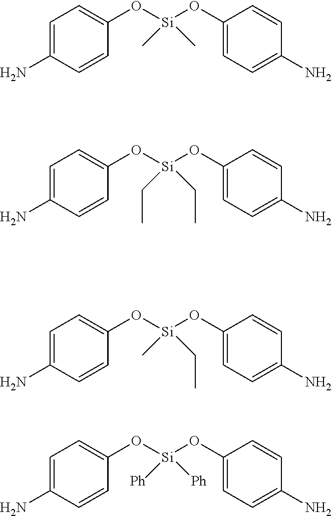 [SMILES: C[Si](C)(Oc1ccc(N)cc1)Oc1ccc(N)cc1 ; CC[Si](CC)(Oc1ccc(N)cc1)Oc1ccc(N)cc1 ; CC[Si](C)(Oc1ccc(N)cc1)Oc1ccc(N)cc1 ; Nc1ccc(O[Si](Oc2ccc(N)cc2)(c2ccccc2)c2ccccc2)cc1]

Specific examples of other diamine for forming the polyimide P include the following.

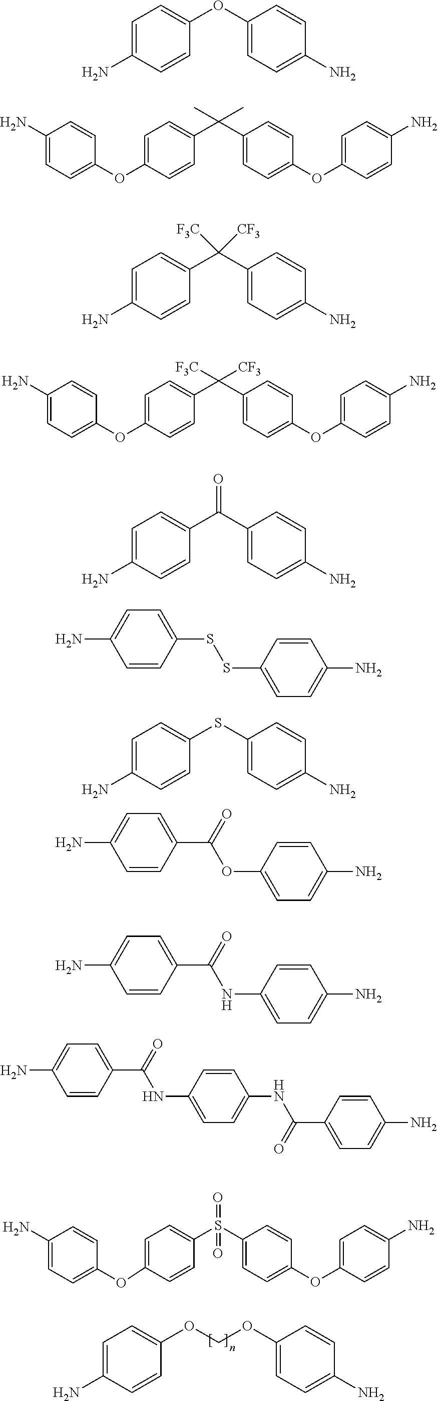

Specific examples of the acid anhydride for forming the polyimide P include the following.

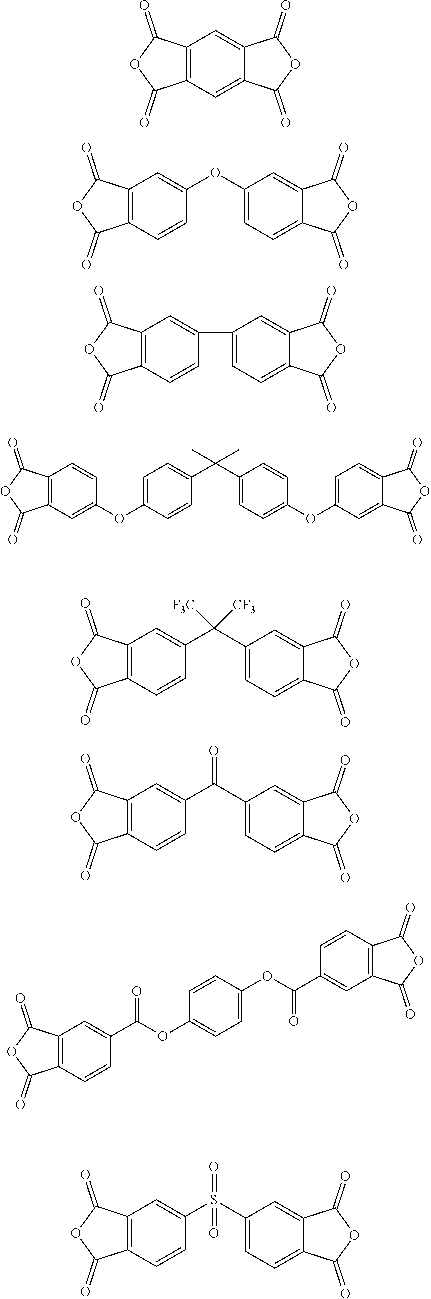

The physical properties of the polyimide P can be appropriately adjusted in accordance with the combination of a diamine and an acid anhydride which are used for the synthesis. Examples of the physical properties of the polyimide P include the heat resistance, the solvent resistance, the transparency, the permittivity, and the thermal expansion coefficient. As an example, when the diamine or the acid anhydride includes an aromatic ring in the main chain and has a rigid structure, the heat resistance and the solvent resistance of the polyimide P can be improved, and the thermal expansion coefficient can be adjusted to a low value. When the diamine or the acid anhydride has an alicyclic hydrocarbon group, the transparency of the polyimide P can be improved, and the permittivity can be adjusted to a low value. In synthesis of the polyimide P, regarding each of the diamine or the acid anhydride, two or more types may be used in combination.

The polyimide P can realize the heat resistance and the solvent resistance at the same level as that of the polyimide in the related art. Consequently, the polyimide P can be used for the applications akin to that of the polyimide in the related art. As an example, the polyimide P can be used as a resin contained in a substrate material or a composite material such as a fiber-reinforced plastic.

### Imide Compound Producing Method

As described above, the polyimide P has a Si—O—C bond in the main chain and is composed of a non-crosslinked structure. The polyimide P having such a configuration can be readily decomposed, and an imide compound that is a decomposition product of the polyimide P can be thereby obtained.

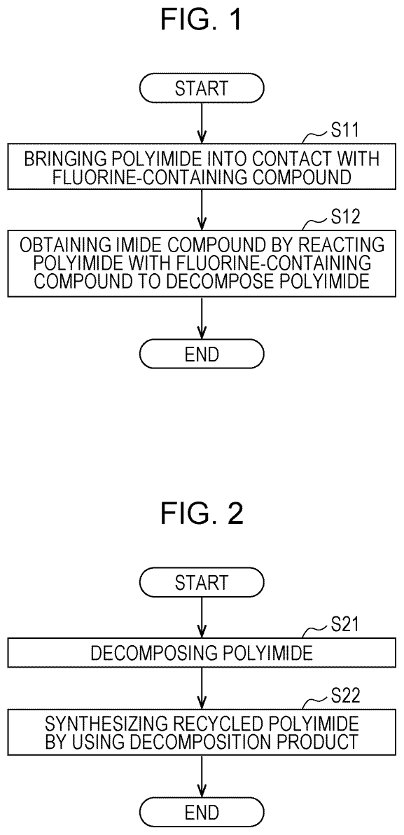

The imide compound can be produced by, for example, the following method. FIG. 1 is a flow chart illustrating an imide compound producing method. Initially, in Step S11, the polyimide P is brought into contact with a fluorine-containing compound. The fluorine-containing compound may include a fluoride salt. The fluoride salt is soluble in water, organic solvents, and the like. The fluoride salt may be an inexpensive ammonium-based fluoride salt which is relatively readily available. The ammonium-based fluoride salt tends to have appropriate solubility in a solvent. The fluoride salt may contain tetrabutylammonium fluoride which is an ammonium-based fluoride salt.

In Step S11, the polyimide P may be brought into contact with the fluorine-containing compound in a solvent. Regarding the solvent, a polar solvent, such as water or tetrahydrofuran (THF), can be used.

Subsequently, in Step S12, the polyimide P is reacted with the fluorine-containing compound. The reaction between the polyimide P and the fluorine-containing compound can be performed by, for example, a state in which the polyimide P is in contact with the fluorine-containing compound being left to stand. In Step S12, the reaction can be facilitated by adjusting the usage of the fluorine-containing compound, the reaction temperature, with or without agitation, and the like.

When the polyimide P is reacted with the fluorine-containing compound, the Si—O bond in the polyimide P is cut, and the polyimide P is decomposed. Consequently, an imide compound having an alcohol structure such as a phenol structure at a terminal is obtained as a decomposition product. As an example, when the polyimide P including the constitutional unit A1 is decomposed, an imide compound denoted by Formula (2) can be obtained. In Formula (2), X, Y, and Z are the same as the above described with respect to Formula (A1).

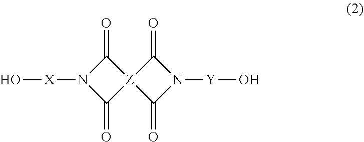

### Recycled Polyimide Producing Method

The decomposition product of the polyimide P can be subjected to further molecular conversion. In particular, when the decomposition product is an imide compound having an alcohol structure at a terminal, molecular conversion can be readily performed. Performing molecular conversion enables the polyimide P to be reused. In other words, the polyimide P can be upcycled. As an example, a recycled polyimide P1 can also be synthesized by using the decomposition product of the polyimide P. The composition of the recycled polyimide P1 may differ from or may be the same as the composition of the polyimide P.

The recycled polyimide P1 can be produced by, for example, the following method. FIG. 2 is a flow chart illustrating a recycled polyimide P1 producing method.

Initially, in Step S21, the polyimide P is decomposed. The polyimide P can be decomposed by, for example, Step S11 and Step S12 above. A decomposition product of the polyimide P can be obtained by decomposing the polyimide P. As described above, the decomposition product of the polyimide P is, for example, an imide compound having an alcohol structure at a terminal. When several types of imide compounds are obtained by decomposition of the polyimide P, a separation operation and a refining operation may be performed, as the situation demands.

Subsequently, in Step S22, the recycled polyimide P1 is synthesized by using the decomposition product of the polyimide P. The synthesis condition of the recycled polyimide P1 can be appropriately set in accordance with the composition of the above-described decomposition product, the composition of an intended recycled polyimide P1, and the like. Consequently, according to the producing method of the present embodiment, the recycled polyimide P1 can be produced from the polyimide P so that the polyimide P can be reused.

### EXAMPLES

The present disclosure will be described below in further detail with reference to the examples. In this regard, the examples below are exemplifications, and the present disclosure is not limited to the examples below.

To begin with, an acid anhydride and a diamine were prepared as raw materials for synthesizing a polyimide. In particular, regarding the acid anhydride, Compound A (produced by TOKYO KASEI KOGYO CO., LTD.) and Compound B (produced by Sigma-Aldrich) below were prepared. Regarding the diamine, Compound C and Compound D (produced by TOKYO KASEI KOGYO CO., LTD.) below were prepared. Further, regarding a solvent used for the reaction, dimethylacetamide (produced by FUJIFILM Wako Pure Chemical Corporation, Super Dehydrated Grade) was prepared.

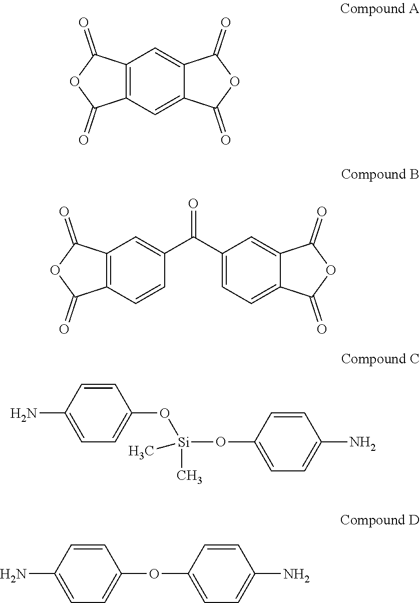 [SMILES: O=c1oc(=O)c2cc3c(=O)oc(=O)c3cc12 ; O=C(c1ccc2c(c1)C(=O)OC2=O)c1ccc2c(c1)C(=O)OC2=O ; C[Si](C)(Oc1ccc(N)cc1)Oc1ccc(N)cc1 ; Nc1ccc(Oc2ccc(N)cc2)cc1]

### Synthesis of Compound C

Compound C was synthesized in conformity with a method described in Thermochimica Acta 2019, 671, 119-126. Compound C was identified by ¹H-NMR.

### Example 1

### Synthesis of Polyimide

A polyimide was synthesized by performing the following operation in a nitrogen atmosphere. Initially, 1.090 g (5 mmol) of Compound A was weighed, and 8.5 g of dimethylacetamide (super hydrated) was added. A mixture of separately weighed 1.090 g (4 mmol) of Compound C and 0.200 g (1 mmol) of Compound D was added while the obtained dimethylacetamide solution of Compound A was agitated at a rotational speed of about 100 rpm. In such an instance, the mixture was added to the solution little by little over about 2 min. The solution was agitated at room temperature for 30 min so as to obtain a dimethylacetamide solution of a polyamic acid.

Subsequently, a glass plate was coated with the dimethylacetamide solution of a polyamic acid. The dimension of the glass plate was 5 cm square, and the thickness was 1 cm. Next, a film formed of a polyamic acid was obtained by performing heating and drying on a hot plate at 50° C. for 16 hours.

A polyimide of Example 1 was obtained by performing an operation of heating the film formed of a polyamic acid on a hot plate at 80° C. for 1 hour, an operation of heating at 100° C. for 1 hour, and an operation of heating at 130° C. for 1 hour. The polyimide was identified by an infrared absorption spectrum. When the infrared absorption spectrum of the polyimide was compared with the infrared absorption spectrum of the polyamic acid, it was ascertained that absorption derived from an imide group increased at 1,715 cm⁻¹.

### Evaluation of Decomposability

Addition of 3 mL of THF solution containing tetrabutylammonium fluoride (TBAF) at a concentration of 1 mol/L to 100 g of synthesized polyimide was performed, and the resulting mixture was left to stand at room temperature for 48 hours. The polyimide began to dissolve in the solution when the THF solution was added and completely dissolved after a lapse of 48 hours. It is conjectured that the polyimide of Example 1 was decomposed by the reaction with tetrabutylammonium fluoride so as to dissolve in the THF solution.

As a comparative experiment, 3 mL of THF was added to 100 mg of synthesized polyimide. In such an instance, the polyimide did not dissolve in THF after being left to stand at room temperature for 48 hours, and no change was observed even after being left to stand for 96 hours.

### Example 2

A polyimide of Example 2 was synthesized by the method akin to the method of Example 1 except that 0.682 g (2.5 mmol) of Compound C was used and that 0.500 g (2.5 mmol) of Compound D was used. Further, regarding the resulting polyimide, the decomposability was evaluated by the method akin to the method of Example 1, and the same result as the result of Example 1 was obtained.

### Example 3

A polyimide of Example 3 was synthesized by the method akin to the method of Example 1 except that 0.137 g (0.5 mmol) of Compound C was used and that 0.900 g (4.5 mmol) of Compound D was used. Further, regarding the resulting polyimide, the decomposability was evaluated by the method akin to the method of Example 1, and the same result as the result of Example 1 was obtained.

### Example 4

A polyimide of Example 4 was synthesized by the method akin to the method of Example 1 except that 0.068 g (0.25 mmol) of Compound C was used and that 0.950 g (4.75 mmol) of Compound D was used. Further, regarding the resulting polyimide, the decomposability was evaluated by the method akin to the method of Example 1, and the same result as the result of Example 1 was obtained.

### Example 5

A polyimide of Example 5 was synthesized by the method akin to the method of Example 3 except that 1.610 g (5 mmol) of Compound B was used in place of Compound A. Further, regarding the resulting polyimide, the decomposability was evaluated by the method akin to the method of Example 1, and the same result as the result of Example 1 was obtained.

### Example 6

A polyimide of Example 6 was synthesized by the method akin to the method of Example 1 except that 1.365 g (5 mmol) of Compound C was used and that Compound D was not used. However, regarding Example 6, the viscosity of a dimethylacetamide solution of a polyamic acid was low, and a film formed of the polyamic acid could not be produced. Consequently, in Example 6, a powder formed of the polyimide was obtained by producing a powder formed of the polyamic acid and subjecting the powder to heat treatment. Further, regarding the resulting polyimide, the decomposability was evaluated by the method akin to the method of Example 1, and the same result as the result of Example 1 was obtained.

### Comparative Example 1

A polyimide of Comparative example 1 was synthesized by the method akin to the method of Example 1 except that Compound C was not used, that 1.001 g (5.0 mmol) of Compound D was used, and that an operation of heating the film formed of a polyamic acid at 80° C. for 1 hour, an operation of heating at 100° C. for 1 hour, an operation of heating at 130° C. for 1 hour, and an operation of heating at 150° C. for 1 hour were performed.

Regarding the resulting polyimide, the decomposability was evaluated by the method akin to the method of Example 1. As a result, when a THF solution containing tetrabutylammonium fluoride at a concentration of 1 mol/L was used, the polyimide did not dissolve in the solution even after being left to stand at room temperature for 48 hours, and no change was visually observed. Likewise, no change was visually observed even after being left to stand at room temperature for 120 hours. No change was visually observed when compared with a comparative experiment in which only THF was added to the polyimide.

### Comparative Example 2

A polyimide of Comparative example 2 was synthesized by the method akin to the method of Comparative example 1 except that 1.610 g (5 mmol) of Compound B was used in place of Compound A.

Regarding the resulting polyimide, the decomposability was evaluated by the method akin to the method of Example 1. As a result, when a THF solution containing tetrabutylammonium fluoride at a concentration of 1 mol/L was used, the polyimide did not dissolve in the solution even after being left to stand at room temperature for 48 hours, and no change was visually observed. Likewise, no change was visually observed even after being left to stand at room temperature for 120 hours. No change was visually observed when compared with a comparative experiment in which only THF was added to the polyimide.

### Measurement of Weight Average Molecular Weight

Regarding the polyimides synthesized in the examples and the comparative examples, the molecular weight distribution was measured under the following conditions, and the weight average molecular weight was specified. The results are presented in Table 1.

### Measurement Conditions

Apparatus: Liquid Chromatograph System (LC-Vp produced by SHIMADZU CORPORATION)
Column: TSKgel SuperAWM-HLSuperAW2500 (produced by Tosoh Corporation)
Eluent: N,N-dimethylformamide+30 mmol/L lithium bromide+10 mmol/L phosphoric acid
Flow rate: 0.5 mL/min
Injection volume: 40 μL
Column temperature: 40° C.
Standard sample: monodisperse polyethylene oxide, polyethylene glycol
Detector: differential refractometer (RI)

TABLE 1

| | Number of silicon | | Weight average | Type |
|---|---|---|---|---|
| | atoms/number of | | molecular | of acid |
| | imide groups | Decomposability | weight | anhydride |
| Example 1 | 40% | good | 4,100 | Compound A |
| Example 2 | 25% | good | 4,000 | Compound A |
| Example 3 | 5% | good | 14,000 | Compound A |
| Example 4 | 2.5% | good | 12,000 | Compound A |
| Example 5 | 5% | good | 14,000 | Compound B |
| Example 6 | 50% | good | 1,200 | Compound A |
| Comparative | 0% | poor | 61,000 | Compound A |
| example 1 | | | | |
| Comparative | 0% | poor | 18,000 | Compound B |
| example 2 | | | | |

In Table 1, the decomposability of the polyimide that dissolved in the THF solution containing TBAF is expressed as “good”, and the decomposability of the polyimide that did not dissolve in the THF solution containing TBAF is expressed as “poor”. As is clear from Table 1, the polyimides having a Si—O—C bond in the main chain of the examples had favorable decomposability and were suitable for reuse compared with the comparative examples. In particular, the polyimides of the examples could be simply decomposed at room temperature by using the fluorine-containing compound.

Further, as is clear from Table 1 and the like, the weight average molecular weight of the polyamic acid tends to decrease with increasing ratio of Compound C used. It is conjectured that the cause of the result is due to a silicon atom portion of the polyamic acid being susceptible to hydrolysis so that cut positions in the main chain of the polyamic acid increases in accordance with the molar fraction of silicon atom and a remarkable decrease in the molecular weight readily occurs.

Regarding Example 6, since the weight average molecular weight of the polyamic acid is 1,200 and was relatively small, the viscosity of the dimethylacetamide solution of the polyamic acid was low, and the applicability and the film-formability were low. On the other hand, regarding Examples 1 to 5, the polyamic acid had a weight average molecular weight suitable for application and film formation.

### Measurement Example 1

Next, to identify the molecular structure of the polyimide, the molecular structure of a decomposition product thereof, and the like, the following measurement was performed.

### NMR Tube Experiment

### Synthesis of Polyamic Acid

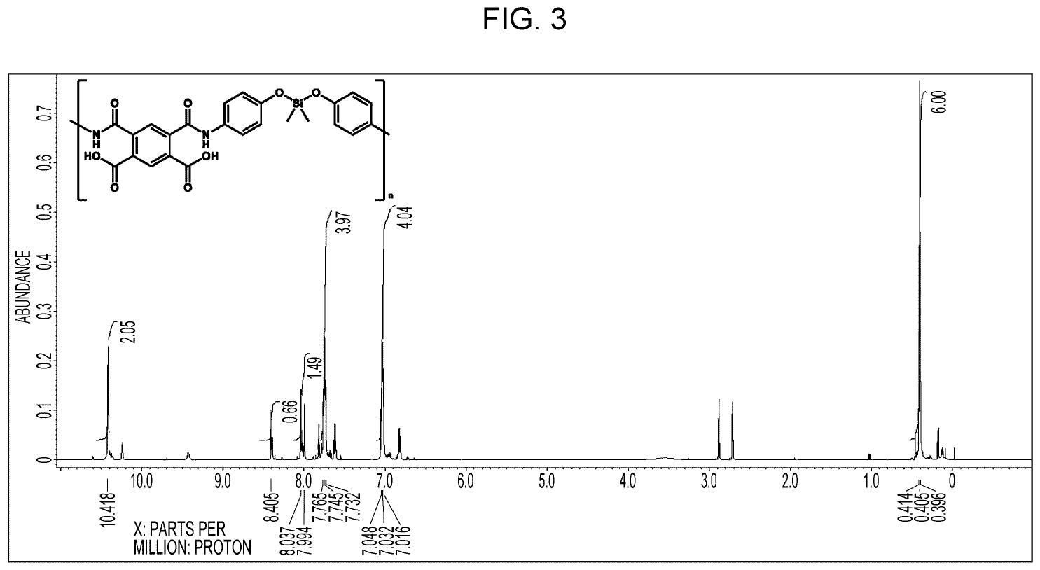

An NMR tube experiment by using a deuterated DMF solvent was performed with a scale of about 1/1,000 of Example 6. In the experiment, when Compound C was added to the deuterated DMF solvent of Compound A, generation of a polyamic acid was ascertained by ¹H-NMR after a lapse of about 10 min at room temperature. FIG. 3 is a graph illustrating a ¹H-NMR spectrum of the polyamic acid in Measurement example 1.

The ¹H-NMR spectrum of the polyamic acid was as described below.

¹H-NMR (600 MHz, DMF-d7), δ (ppm): 10.42 (s, 2H), 8.41-8.00 (s, 2H), 7.75 (m, 4H), 7.03 (m, 4H), 0.41 (t, J=5.4 Hz, 6H)

### Infrared Absorption Spectrum of Polyimide

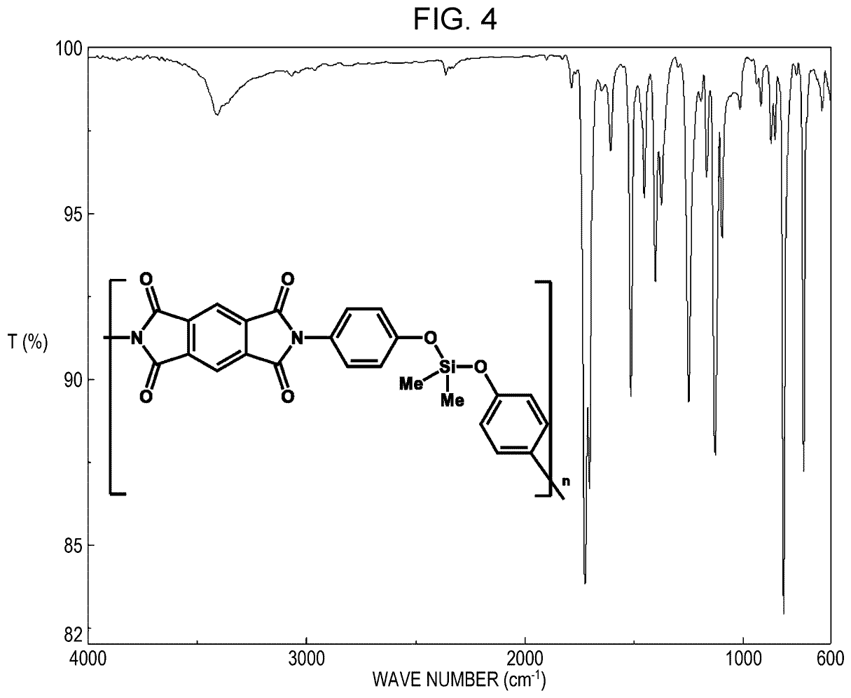

The polyimide synthesized in Example 6 was subjected to infrared spectrometry so as to obtain an infrared absorption spectrum. FIG. 4 is a graph illustrating an infrared absorption spectrum of the polyimide in Measurement example 1. As clearly illustrated in FIG. 4, absorption derived from an imide group was ascertained on the infrared absorption spectrum of the polyimide.

### NMR Tube Experiment

### Decomposition of Polyimide

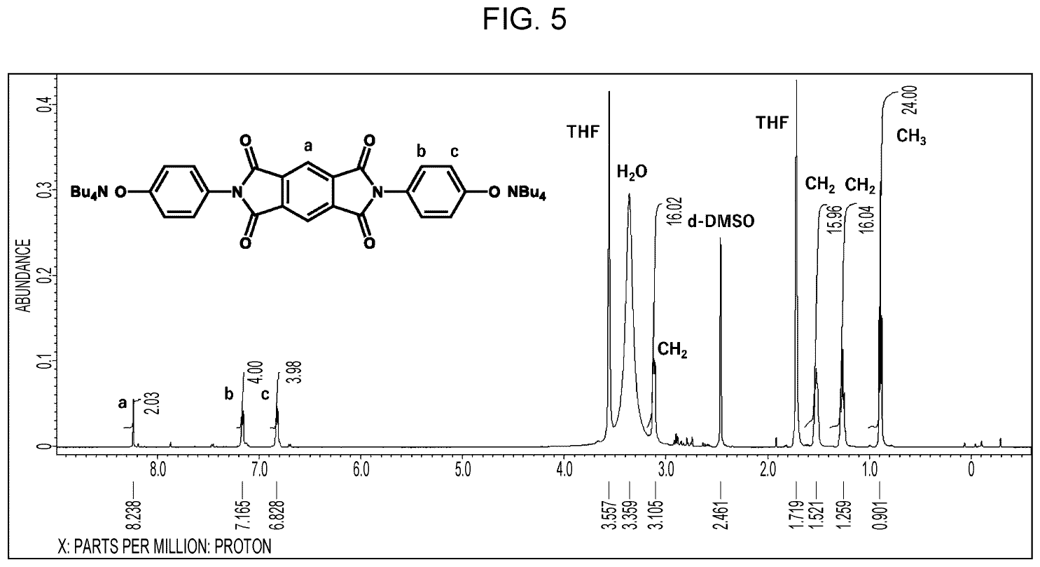

The polyimide synthesized in Example 6 and the deuterated DMF solvent were added to the NMR tube, and ¹H-NMR measurement was performed. As a result, the polyimide did not dissolve in the deuterated DMF solvent, and a signal derived from the polyimide was not obtained. Subsequently, a THF solution containing 1 mol/L of tetrabutylammonium fluoride was added, and ¹H-NMR measurement was performed immediately. Consequently, a ¹H-NMR signal derived from a decomposition product of the polyimide was obtained. FIG. 5 is a graph illustrating a ¹H-NMR spectrum of a decomposition product of the polyimide in Measurement example 1.

It was identified from FIG. 5 that the decomposition product was a compound denoted by Formula (3). This compound is obtained by the Si—O bond of the polyimide being cut. O⁻ at a terminal of the compound formed a salt with ⁺NBu₄.

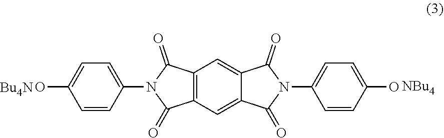 [SMILES: O=c1c2cc3c(=O)n(-c4ccc(O)cc4)c(=O)c3cc2c(=O)n1-c1ccc(O)cc1 ; "Bu4N" ; "NBu4"]

Likewise, regarding the polyimides of Example 1 to Example 5, it is conjectured that the Si—O bond is cut by the reaction with the fluorine-containing compound, and a decomposition product is generated. Regarding the evaluation of the decomposability of Example 1 to Example 6, it is conjectured that the polyimide completely dissolved in the THF solution due to the decomposition product being generated from the polyimide.

The polyimide P according to the present disclosure tends to have excellent solvent resistance and thermophysical properties. Further, the polyimide P can be simply decomposed and removed when unneeded. Consequently, the polyimide P can be used as a resin contained in a substrate material or a composite material such as a fiber-reinforced plastic.

What is claimed is:

1. A polyimide comprising:
a non-crosslinked structure including a main chain,
wherein the main chain includes a Si—O—C bond.

2. The polyimide according to claim 1,
wherein the main chain includes a C—O—Si—O—C bond.

3. The polyimide according to claim 1, wherein
the main chain includes a group denoted by —OSi(R₁)(R₂)O—,
at least one oxygen atom included in the group bonds to a carbon atom adjacent to the group to form the Si—O—C bond, and
in the group, R₁ and R₂ each independently include at least one atom selected from the group consisting of H, C, N, O, S, F, Cl, Br, and I.

4. The polyimide according to claim 1, wherein
the non-crosslinked structure includes a first constitutional unit denoted by Formula (A1), 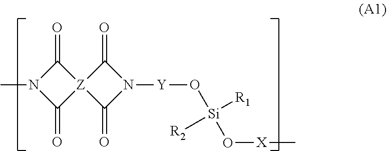
in Formula (A1),
R₁ and R₂ each independently include at least one atom selected from the group consisting of H, C, N, O, S, F, Cl, Br, and I,
X and Y each independently represent a divalent group including at least one atom selected from the group consisting of H, C, N, O, S, F, Cl, Br, and I,
Z represents a tetravalent group including at least one atom selected from the group consisting of H, C, N, O, S, F, Cl, Br, and I, and
at least one selected from the group consisting of X and Y includes a carbon atom that bonds to an adjacent oxygen atom to form the Si—O—C bond.

5. The polyimide according to claim 1, wherein
the non-crosslinked structure includes a second constitutional unit denoted by Formula (A2), 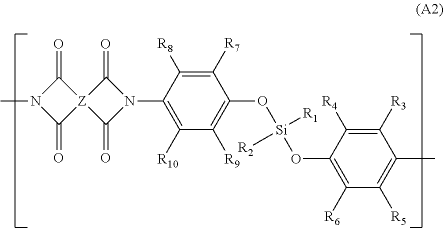
in Formula (A2),
R₁ to R₁₀ each independently include at least one atom selected from the group consisting of H, C, N, O, S, F, Cl, Br, and I, and
Z represents a tetravalent group including at least one atom selected from the group consisting of H, C, N, O, S, F, Cl, Br, and I.

6. The polyimide according to claim 1, wherein
the non-crosslinked structure includes a third constitutional unit denoted by Formula (A3), 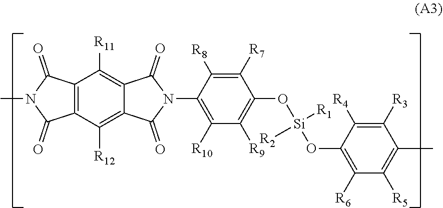
in Formula (A3), R₁ to R₁₂ each independently include at least one atom selected from the group consisting of H, C, N, O, S, F, Cl, Br, and I.

7. The polyimide according to claim 1, wherein
the non-crosslinked structure includes a fourth constitutional unit denoted by Formula (A4), 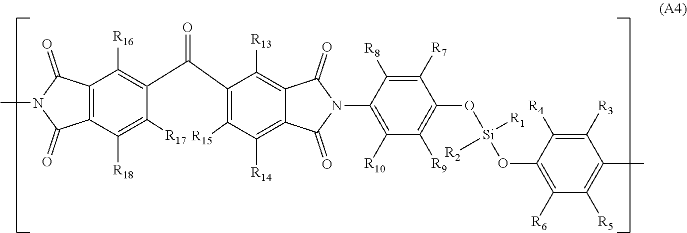
in Formula (A4), R₁ to R₁₀ and R₁₃ to R₁₈ each independently include at least one atom selected from the group consisting of H, C, N, O, S, F, Cl, Br, and I.

8. The polyimide according to claim 3,
wherein R₁ and R₂ each independently represent a hydrogen atom or a hydrocarbon group having a carbon number of greater than or equal to 1 and less than or equal to 6.

9. A polyimide comprising:
a main chain including a Si—O—C bond,
wherein a ratio of the number of silicon atoms included in the main chain to the number of imide groups included in the main chain is greater than or equal to 2% and less than or equal to 50%.

10. The polyimide according to claim 1,
wherein a weight average molecular weight is greater than or equal to 1,000.

11. A producing method of an imide compound, the producing method comprising:
bringing the polyimide according to claim 1 into contact with a fluorine-containing compound, and
obtaining an imide compound that is a decomposition product of the polyimide by reacting the polyimide with the fluorine-containing compound.

12. The producing method according to claim 11,
wherein the fluorine-containing compound includes a fluoride salt.

13. The producing method according to claim 12,
wherein the fluoride salt includes tetrabutylammonium fluoride.

14. A producing method of a recycled polyimide, the producing method comprising:
obtaining a decomposition product of the polyimide according to claim 1 by decomposing the polyimide, and
synthesizing a recycled polyimide by using the decomposition product.
